(19) United States
(12) Patent Application Publication
(10) Pub. No.: US 2015/0310330 A1
(43) Pub. Date: Oct. 29, 2015

(54) Computer-implemented method and system for digitizing decision-making processes

(71) Applicant: George Guonan Zhang, Crofton, MD (US)

(72) Inventor: George Guonan Zhang, Crofton, MD (US)

(21) Appl. No.: 14/264,104

(22) Filed: Apr. 29, 2014

(51) Int. Cl. G06N 5/02; G06F 17/30; G06N 99/00

(52) U.S. Cl. CPC G06N 5/022; G06N 99/005; G06F 17/30961

(57) ABSTRACT

A computer-implemented method and system defines a uniform decision-tree formation to store decision-making processes. Each node in a decision tree represents a factor decision. All nodes of a decision tree are interlinked in a hierarchical structure based on a decision-making process. Any decision tree of the present invention can serve as a sub-tree of another decision tree. Users can convert their decision-making processes into decision trees and make collaborative decisions through network.

### BACKGROUND OF THE INVENTION

1. Field of the Invention

The present invention relates generally to a system and method of digitizing decision-making processes and automation of knowledge work. This invention intends to significantly improve the efficiency of knowledge sharing and decision-making processes.

2. Description of the Related Art

We store our analytical logic and decision-making processes (i.e. knowledge) in our heads, documents, or packaged software application. This invention provides another way to store our knowledge. We share knowledge through discussions, documents, or packaged software applications. This invention creates another way for people to share their knowledge electronically.

Currently the way people make decisions requires a great deal of effort and is slow, and also inconsistent. We often know how we derived our results. It is very useful and helpful for us to retrace thinking steps and correct them in an adaptive manner. This invention develops methods and processes that allow people to digitize their decision-making processes and make collaborative decisions or analyses using a variety of expertise through networking computers and/or mobile devices, anywhere and anytime, which ensures consistency and transparency of their decision-making or analysis processes.

### BRIEF DESCRIPTION OF DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram showing major components of a factor-decision node, in accordance with one or more aspects of the present disclosure.

FIG. 2 is a logic diagram illustrating factor-decision-action relations of a node, in accordance with one or more aspects of the present disclosure.

FIG. 3 is a conceptual diagram showing a topological structure of a distributed decision tree, in accordance with one or more aspects of the present disclosure.

FIG. 4 is a flow chart illustrating operations of constructing a decision tree, in accordance with one or more aspects of the present disclosure.

FIG. 5 is a flow chart illustrating operations of adding a node or sub-tree, in accordance with one or more aspects of the present disclosure.

FIG. 6 is a flow chart illustrating operations of copying a node or sub-tree, in accordance with one or more aspects of the present disclosure.

FIG. 7 is a flow chart illustrating operations of deleting a node or sub-tree, in accordance with one or more aspects of the present disclosure.

FIG. 8 is a flow chart illustrating operations of moving a node or sub-tree, in accordance with one or more aspects of the present disclosure.

FIG. 9 is a flow chart illustrating operations of pasting a node or sub-tree, in accordance with one or more aspects of the present disclosure.

FIG. 10 is a flow chart illustrating a decision-making process using a decision tree, in accordance with one or more aspects of the present disclosure.

### DETAILED DESCRIPTION

The present invention defines a uniform decision tree formation, of which nodes of all decision trees have the same components. The present invention introduces methods to define factor-decision nodes and construct decision trees or distributed decision trees using the factor-decision nodes. A decision tree can be stored in an encrypted format at multiple storage locations. Furthermore, the diagrams of present invention illustrate how to perform an analysis or decision-making process using a decision tree.

Given the description herein, it would be obvious to one skilled in the art of implementing the present invention in any general computer platform including computer processors, computer servers, computer devices, smart phones, and cloud servers.

Description in these terms is provided for convenience only. It is not intended that the invention be limited to applications described in this example environment. In fact, after reading the following description, this will become apparent to a person skilled in the relevant art of how to implement the invention in alternative environments.

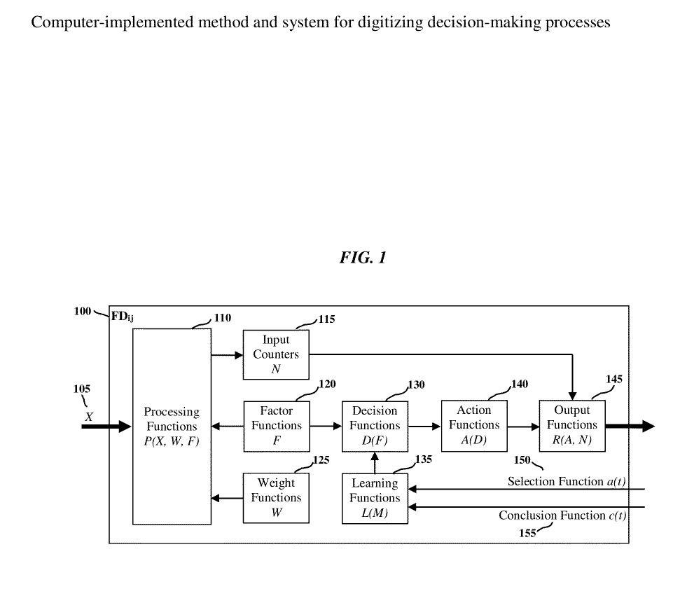

FIG. 1 is a block diagram showing major components of a factor-decision node 100. All nodes of decision trees of the present invention are comprised of the same components that include a set of processing functions 110, a set of input counters 115, a set of factor functions 120, a set of weight functions 125, a set of decision functions 130, a set of action functions 140, an output function 145, a selection function 150, a conclusion function 155, and a set of learning functions 135. A function of the present invention can be an executable program, data link, constant value, control command, or database query, where the value of the function can be a number, range, fuzzy value, percentage, multiple status, text, or statistics.

A set of factor functions 120, F={F₁, . . . Fᵢ, . . . , Fₙ}, defines a range and values of a decision factor, where a function Fᵢ can be defined as an executable program, data link, constant value, or database query. Users can define their own set of factor functions F. For example, a range and values of a factor for marketing experience can be F={“Less”, “Some”, “Average”, “Good”, “Excellent”}. A range and values of a factor for average incomes by ages can be F={AVG(16≦age<22), AVG(22≦age<30), AVG(30≦age<50), AVG(50≦age<60), AVG(age≧60)}, where the AVG is a database query function and the value of the AVG is depended on the range of ages.

A set of action functions 140, A={A₁, . . . Aᵢ, . . . , Aₙ}, defines actions for factor values, where an action function A, can be an executable program, constant value, data link, control command, or database query. The values of the action functions A map to values of a set of factor functions F of its parent node. Users can define their set of action functions A. For example, a set of actions for stock trading decisions can be A={SELL(s), HOLD(s), ACCUMULATE(s), BUY(s)}, where the s is number of shares.

A set of decision functions 130, D(F)={D₁(F₁), . . . Dᵢ(Fᵢ), . . . , Dₙ(Fₙ)}, defines decision relations between factor values and actions, where a decision function, Dᵢ(Fᵢ), can be an executable program or constant value. The decision function Dᵢ(Fᵢ) determines which action or A, is taken for a factor value of the Fᵢ or the Dᵢ(Fᵢ)=Aⱼ. Users can define their set of decision functions D(F). For example, a decision function determines that a person has less marketing experience if his age is between 16 and 22 or Dᵢ(“16≦age<22”)=“Less”, where Fᵢ=“16≦age<22” and Aⱼ=“Less”.

A set of factor inputs 105, X={x₁, . . . , xⱼ, . . . , xₘ}, is collected from human inputs, child nodes, data sources, and/or software applications, where all factor inputs for a node are mapped into its factor value or xⱼε{F₁, . . . , Fᵢ, . . . , Fₙ} and 1≦j≦m. For example, F={“Less”, “Some”, “Average”, “Good”, “Excellent”} and X={“Less”, “Some”, “Some”, “Less”, “Some”, “Less”, “Some”, “Some”, “Less”, “Some”, “Average”, “Average”, “Less”, “Less”}, where m=14.

A set of input weight functions 125, W(X)={W₁(x₁), . . . Wⱼ(xⱼ), . . . , Wₘ(xₘ)}, assigns weight values to corresponding factor inputs. Users can define their own set of weight functions W. For example, a weighed factor input value can be Wⱼ(xⱼ)=wⱼ×Unit(xⱼ), where wⱼ is 0≦wⱼ≦1, Unit(xⱼ)=1, and 1≦j≦m.

A set of input counters 115, N={N₁, . . . , Nᵢ, . . . , Nₙ}, records weighted values of each factor Fᵢ based on factor inputs X and weights W. The input counters are used to determine which action will be an output of the node. For example, if Nᵢ>0, the action Dᵢ(Fᵢ)=Aⱼ can be an output candidate.

A set of processing functions 110, P(X, W, F)={P₁(X, W, F₁), . . . Pᵢ(X, W, Fᵢ), . . . , Pₙ(X, W, Fₙ)}, collects the factor inputs X from specified sources including human inputs through computer devices, data extraction functions, and/or outputs of its child nodes. The factor inputs are mapped to factor values or xⱼε{F₁, . . . , Fᵢ, . . . , Fₙ} and 1≦j≦m. The processing function Pᵢ(X, W, Fᵢ) calculates each weighted value Nᵢ based on the factor inputs in the set of X and weight functions in the set of W or Pᵢ(X, W, Fᵢ)=Nᵢ, where Nᵢ=Σⱼ₌₁^{m} Wⱼ(xⱼ)|ₓ_{ⱼ}_{=F}_{ᵢ}) and 1≦i≦n. Users can define their processing function P(X, W, F).

For example,
Assume that
Wⱼ(xⱼ)=wⱼ×Unit(xⱼ), where 0≦wⱼ≦1, Unit(xⱼ)=1, and 1≦j≦m
{w₁, . . . wⱼ, . . . , wₘ}={0.5, 0.8, 0.5, 1, 1, 0.8, 0.4, 1, 0.9, 06, 1, 0.8, 0.7, 1}
F={“Less”, “Some”, “Average”, “Good”, “Excellent”}
X={“Less”, “Some”, “Some”, “Less”, “Some”, “Less”, “Some”, “Some”, “Less”, “Some”, “Average”, “Average”, “Less”, “Less”}
W(X)={w₁×Unit(“Less”), w₂×Unit(“Some”), w₃×Unit(“Some”), w₄×Unit(“Less”), w₅×Unit(“Some”), w₆×Unit(“Less”), w₇×Unit(“Some”), w₈×Unit(“Some”), w₉×Unit(“Less”), w₁₀×Unit(“Some”), w₁₁×Unit(“Average”), w₁₂×Unit(“Average”), w₁₃×Unit(“Less”), w₁₄(“Less”)}={0.5, 0.8, 0.5, 1, 1, 0.8, 0.4, 1, 0.9, 06, 1, 0.8, 0.7, 1}
Then the weighted values of the set of input counters N are

N={N₁, N₂, N₃, N₄, N₅}={4.9, 4.3, 1.8, 0, 0}.

An output function R(A, N) 145 generates a set of actions, [Aₖ, Aⱼ, . . . , Aₚ], as action or decision options based on weighted values in the set N, where 1≦k≦j≦p≦n. Users can define their own output function. For example, assume that a selection rule of an output function is based on Nᵢ>0, A={SELL(s), HOLD(s), ACCUMULATE(s), BUY(s)}, and N=[4.9, 4.3, 1.8, 0], then R(A, N)={A₁, A₂, A₃}={SELL(s), HOLD(s), ACCUMULATE(s)}. The output of the function R(A, N) of a node can be a data source of decision reports. The output of the function R(A, N) of a root node can be used to trigger actions or other decision processes.

A selection function a(t) 150 collects a final action Aᵣ that is chosen at time t from either a selection process or its parent node, where Aᵣε{Aₖ . . . Aⱼ, . . . , Aₚ} and k≦r≦p. The action Aᵣ is mapped to a factor Fᵢ or Aᵣ=Dᵢ(Fᵢ). The factor Fᵢ maps to an action Aᵢ of its child nodes, where the action Aᵢ may be different for each child node. The action Aᵢ is used as a final action of the child nodes. For example, assume that the a(t) of a node FD₀₀ collects a final action Aᵣ=A₁=SELL(s), the A₁=D₂(F₂)=D₂(“Poor Sales”) maps to F₂=“Poor Sales” of the node FD₀₀, the F₂ maps to an action Aᵢ=A₃=“Poor Sales” of a child node FD₁₀. The action A₃ is a final action to be taken at time t for the child node FD₁₀.

A conclusion function c(t) 155 collects a correct action A_{q} to be considered to an action Aᵣ to be taken at time t from either an input or parent node, where A_{q}ε{A₁ . . . Aᵢ, . . . , Aₙ}, and 1≦q≦n. The A_{q} is mapped to a factor Fᵢ or A_{q}=Dᵢ(Fᵢ). The Fᵢ maps to actions Aᵢ of its child nodes, where the action Aᵢ may be different for each child node. The action Aᵢ will be used as a correct action of the child nodes. For example, assume that the c(t) of a node FD₀₀ collects a correct action A_{q}=A₂=HOLD(s) for an action Aᵣ=A₁ at time t, the A₂=D₃(F₃)=D₃(“Low Sales”) maps to F₃=“Low Sales”, and the F₃=“Low Sales” maps to an action Aᵢ=A₂=“Low Sales” of a child node FD₁₀. The action A₂ is a correct action to be considered at time t for the child node FD₁₀.

A set of matrices 135, M={M₁, . . . , Mᵢ, . . . , Mₙ}, stores decision historical data. Each Mᵢ stores the last s pairs of taken and correct actions Mᵢ={[a(t₁), c(t₁)], [a(tⱼ), c(tⱼ)], . . . , [a(tₛ), c(tₛ)]}, where a(tⱼ) is an action that associates with a factor Fᵢ or Dᵢ(Fᵢ)=a(tⱼ), s is the length of the matrix Mᵢ, and tⱼ is a time sequence. For example, a matrix M₃ stores the last eight pairs of taken and correct actions M₃={[a(t₁), c(t₁)], [a(t₂), c(t₂)], [a(t₃), c(t₃)], [a(t₄), c(t₄)], [a(t₅), c(t₅)], [a(t₆), c(t₆)], [a(t₇)], [a(t₈), c(t₈)]}={[A₁, A₁], [A₁, A₁], [A₁, A₂], [A₂, A₁], [A₁, A₁], [A₁, A₃], [A₁, A₁], [A₁, A₂]} for the factor F₃.

A set of learning functions 135, L(M)={L₁(M₁), . . . Lᵢ(Mᵢ), . . . , Lₙ(Mₙ)}, adjusts the decision functions D(F) based on statistics of decision historical data in the matrixes M. The Lᵢ(Mᵢ) modifies the current decision function Dᵢ(Fᵢ)=Aᵣ to a new decision function Dᵢ′(Fᵢ)=A_{q} based on statistics of decision historical data in the matrix Mᵢ, where 1≦i≦n, 1≦r≦n, and 1≦q≦n. Users can define their set of learning functions L(M). For example, assume M₃={[A₁, A₁], [A₁, A₂], [A₁, A₂], [A₁, A₂], [A₁, A₂], [A₁, A₃], [A₁, A₂], [A₁, A₂]} and the rule of the L₃(M₃) is based on percentages of correct actions. Since 60% correct actions are A₂ in the M₃, therefore, L₃(M₃) modifies D₃(F₃)=A₁ to D₃(F₃)=A₂ for the future decisions.

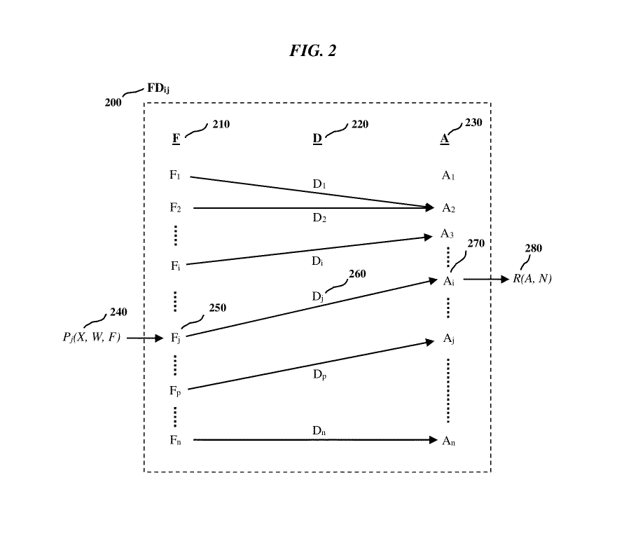

FIG. 2 is a logic diagram illustrating factor-decision-action relations of a node 200. When a processing function Pⱼ(X, W, Fⱼ) 240 determines that a factor value Fⱼ 250 in the set of factor functions F 210 participates in the node decision process, a corresponding decision function Dⱼ(Fⱼ) 260 in the set of decision functions D 210 induces an action Aᵢ 270 in the set of actions A 230. The action A, 270 is an action candidate for the output function R(A, N) 280.

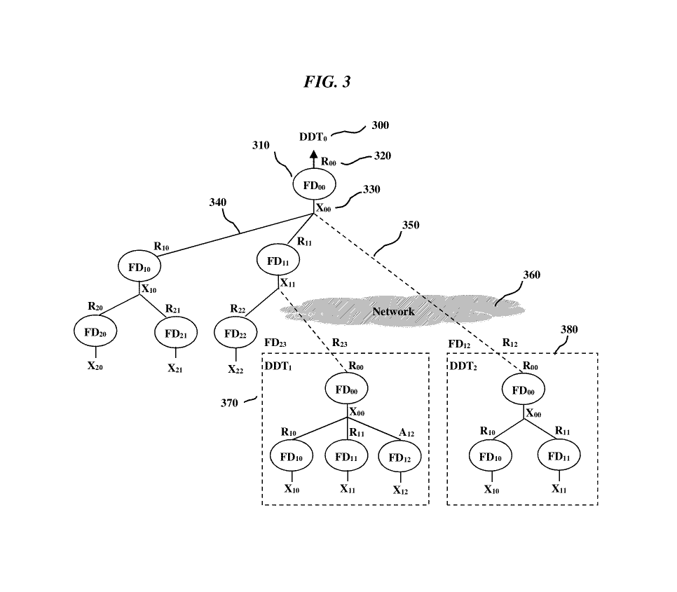

FIG. 3 is a conceptual diagram showing a topological structure of a distributed decision tree DDT₀ 300, wherein two sub-trees DDT₁ 370 and DDT₁ 380 are stored at different storage locations. Each FDᵢⱼ 310 of the distributed decision tree 300 represents a factor decision node, where 0≦i≦2 and 0≦j≦3. Each Rᵢⱼ 320 represents a set of outputs of the factor decision node FDᵢⱼ, where 0≦i≦2 and 0≦j≦3. Each X, 330 represents a set of factor inputs of the factor decision node FDᵢⱼ, where 0≦i≦2 and 0≦j≦3. The set of the Xᵢⱼ includes outputs R₍ᵢ₊₁₎ⱼ, from its child node(s) and/or from factor inputs {x₁, . . . , xⱼ, . . . xₘ}. A solid line 340 indicates that two nodes are internally linked at the same storage location. A dash line 350 indicates that two nodes are linked at different storage locations. A distributed decision tree has at least one sub-tree that is stored at a different storage location. A distributed sub-tree DDT₁ 370 or DDT₁ 380 can be linked through network 360.

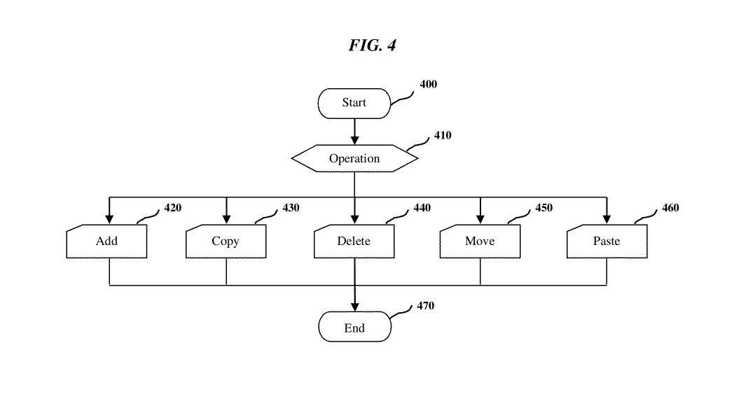

FIG. 4 is a flow chart illustrating operations 400 of constructing a decision tree. Users can choose an operation 410 to add 420, copy 430, delete 440, move 450, or paste 460 a node or a sub-tree and complete the operation 470.

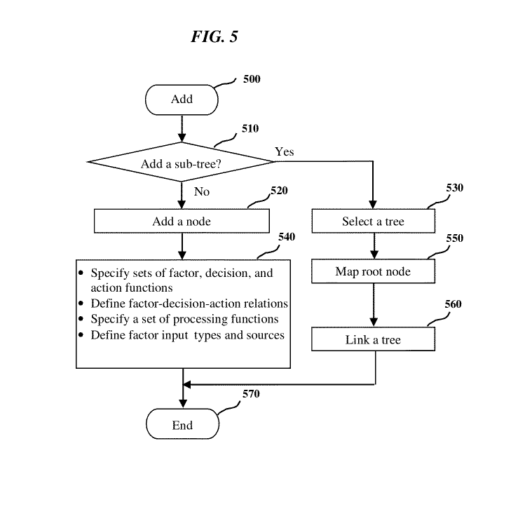

FIG. 5 is a flow chart illustrating an operation 500 of adding a node or sub-tree. If a user decides to add a new node 510, an empty node is linked to a current node as a child node or is used as a root node if the current decision tree is empty 520. The user can specify factor, decision, action functions, factor-decision-action relations, processing functions, and factor input types and sources 540. A factor input type can be a constant or function. A factor input source can be an output from a child node, human input, database, or software application. If a user wants to add a sub-tree 510, the user chooses a decision tree through knowledge systems of the present invention 530, maps action values of root node of the sub-tree to the factor values of the current node 550, and links the root node of the sub-tree to the current node 560. After adding a node or sub-tree is completed, the add operation 570 is ended.

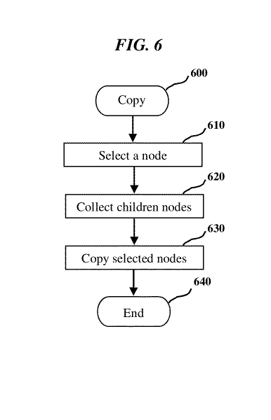

FIG. 6 is a flow chart illustrating operations of copying a node or sub-tree 600. When a user selects a node 610, the application of the present invention collects its child nodes 620, copies this node and its child nodes into a temporary storage (e.g. a clipboard) for a pasting operation 630, and exits the current copying operation 640.

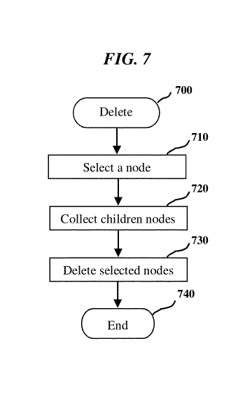

FIG. 7 is a flow chart illustrating operations of deleting a node or sub-tree 700. When a user selects a node 710, the application of the present invention collects its child node 720, deletes this node and its child nodes from the decision tree 730, and exits the current deleting operation 740.

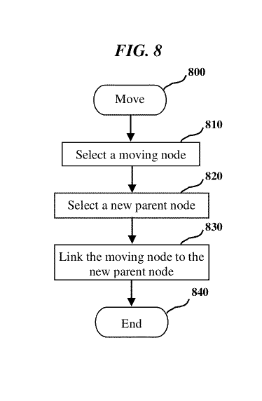

FIG. 8 is a flow chart illustrating operations of moving a node or sub-tree 800. When a user selects a node to be moved 810 and a new parent node 820, the application of the present invention links the moving node to the new parent node 830 and exits the current moving operation 840.

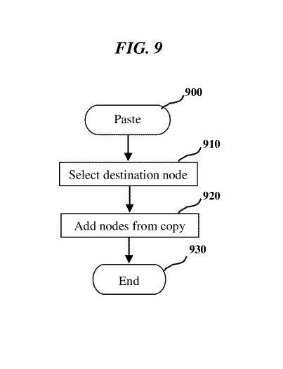

FIG. 9 is a flow chart illustrating operations of pasting a node or sub-tree 900. When a user selects a destination node or parent node for pasting, the application of the present invention adds nodes from temporary storage under the destination node 920 and exits the current pasting operation 930.

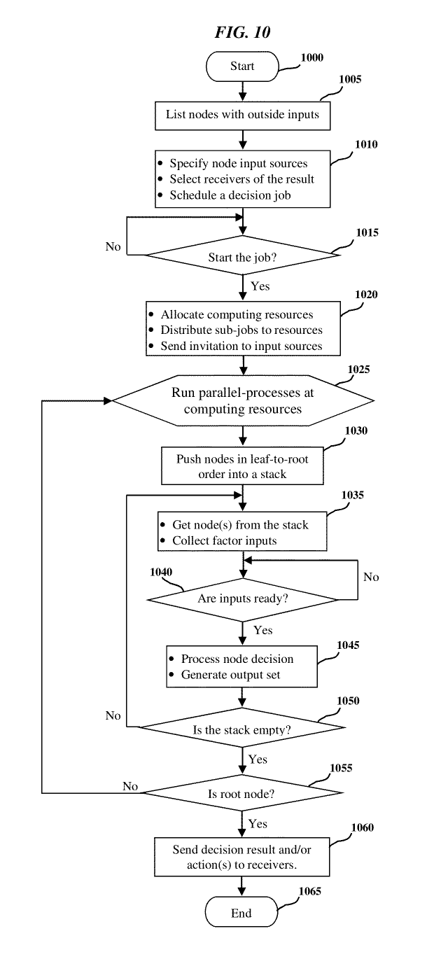

FIG. 10 is a flow chart illustrating a decision-making process using a decision tree 1000. When a user selects a decision tree to make decisions, the application of the present invention lists nodes of the decision tree that need factor inputs from non-child node sources 1005. A user can specify the multiple input sources for a node, select receivers to send the decision reports or results, and schedule a decision-making job 1010. The input sources can be from human inputs, databases, child nodes, and/or software applications. For example, a user can invite people to provide the factor inputs to specified nodes. A receiver can be an email address, mobile phone number, electric device, or software application. The user can select multiple receivers. When a scheduled job starts 1015, the application of the present invention analyzes the structure of the decision tree, allocates available computing resources such as computer processors, distributes sub-jobs or sub-trees to each computing resource, and sends invitations to input sources with a response time 1020. The application of the present invention triggers the decision-making process at each computing resource. All sub-jobs can be parallel processing 1025. At each computing resource, the application of the present invention pushes all local nodes of the decision tree or a sub-tree in leaf-to-root order into a computing stack 1030. At each computing resource, the application of the present invention retrieves one or many nodes from the stack and collects factor inputs for the node(s) 1035, waits until the required factor inputs are collected or response time is over 1040, performs the node decision and passes the node decision results to its parent nodes 1045. If the stack is not empty 1050, continue the decision process 1035, else complete the process at this computing resource. If the current node is not the root node of the decision tree, the application waits until the root node is reached 1055. If the current node is a root node of the decision tree 1055, the application sends the decision results and/or action options to specified receivers 1060, the whole decision process is completed 1065.

In summary, the present invention discloses a uniform knowledge formation, methods to digitize people's analysis or decision-making processes, methods to construct distributed knowledge or decision trees, and processing steps to perform analyses or make decisions with the decision trees.

While various embodiments of the present invention have been described above, it should be understood that they have been presented by way of example only, and not limited to the examples in this text. Thus, the breadth and scope of the present invention should not be limited by any of the above-described exemplary embodiments, but should be defined only in accordance with the following claims and their equivalents.

1. A computer-based system and method of defining a uniform formation using a distributed decision-tree structure to convert and store people's decision-making processes, comprising of:
a) defining all nodes of decision trees using an uniform formation;
b) linking said nodes to form a decision tree;
c) linking two nodes by storage addresses, wherein one is the parent node and the another one is the child node;
d) mapping output values of a node to input values of its parent node;
e) storing said plurality of nodes in a readable storage medium by computer devices;
f) linking another decision tree to the current decision tree as a sub-tree;
g) storing said sub-tree in either the same or a different data storage medium;
h) performing the same decision processing steps in said each node.

2. The method of claim 1, wherein all nodes have the same components that include a set of factor functions, a set of action functions, a set of weight functions, a set of processing functions, a set of input counters, a set of decision functions, a selection function, a conclusion function, an output function, and a set of learning functions.

3. The method of claim 2, further comprising:
a) a set of factor functions, F={F₁, . . . Fᵢ, . . . , Fₙ}, defining values and a range of decision factors, wherein n is a positive integer number;
b) a set of action functions, A={A₁, . . . Aᵢ, . . . , Aₙ}, defining a list of actions;
c) a set of factor inputs, X={x₁, . . . , xⱼ, . . . xₘ}, being collected from human inputs, child nodes, data sources, and/or software applications, where xⱼΣ{F₁, . . . , Fᵢ, . . . , Fₙ}, 1≦j≦m, and m is a positive integer number;
d) a set of weight functions, W(X)={W₁(x₁), . . . Wⱼ(xⱼ), . . . , Wₘ(xₘ)}, assigning weight values to the corresponding factor inputs in the set of X;
e) a set of decision functions, D(F)={D₁(F₁), . . . Dᵢ(Fᵢ), . . . , Dₙ(Fₙ)}, determining each factor-decision-action relation or the Dᵢ(Fᵢ)=Aⱼ, where 1≦j≦n;
f) a set of input counters, N={N₁, . . . , Nᵢ, . . . , Nₙ}, storing weighted input values of each corresponding factor Fᵢ, where 1≦i≦n;
g) a set of processing functions, P(X, W, F)={P₁(X, W, F₁), . . . , Pᵢ(X, W, Fᵢ), . . . , Pₙ(X, W, Fₙ)}, calculating each weighted input value N, of the factor Fᵢ or Pᵢ(X, W, Fᵢ)=Nᵢ based on collected factor inputs and assigned weight values, where 1≦i≦n;
h) an output function R(A, N) producing a set of output actions {Aₖ, . . . , Aⱼ, . . . , Aₚ} based on values in the set of N, where 1≦k, k≦j≦p and p≦n;
i) a selection function a(t) collecting an action Aᵣ being taken at time t, where Aᵣε{Aₖ, . . . Aⱼ, . . . , Aₚ} and k≦r≦p;
j) a conclusion function c(t) collecting an action A_{q} that is considered to be a correct action at time t, where A_{q}ε{A₁, . . . Aᵢ, . . . , Aₙ} and 1≦q≦n;
k) a set of matrices, M={M₁, . . . , Mᵢ, . . . Mₙ}, storing decision historical data, wherein the Mᵢ stores the last s pairs of taken and correct actions {[a(t₁), c(t₁)], . . . [a(tⱼ), c(tⱼ)], . . . , [a(tₛ), c(tₛ)}], wherein the s is a length of the matrix M t, is a time sequence, and Dᵢ(Fᵢ)=a(tⱼ);
l) A set of learning functions, L(M)={L₁(M₁), . . . Lᵢ(Mᵢ), . . . , Lₙ(Mₙ)}, adjusting the decision functions D(F), wherein the Lᵢ(Mᵢ) can modify a decision function from the current Dᵢ(Fᵢ)=Aⱼ to a new decision function Dᵢ′(Fᵢ)=Aₖ based on statistics of decision historical data stored in the matrix M, and 1≦i≦n.

4. The method of claim 3, wherein said a function can be, but not limited to, an executable program, data link, constant value, or database query and the value of a function can be a number, range, fuzzy value, percentage, multiple status, text, or statistics.

5. The method of claim 3, wherein a set of the function P(X, W, F) collects factor inputs from human, child nodes, data sources, and/or software applications, calculates input values with assigned weight functions, and determines which factor value is used in the decision process of the node.

6. The method of claim 1, wherein a set of action functions A={A₁, . . . Aᵢ, . . . , Aₙ} of a node being mapped to a set of factor functions F={F₁, . . . , Fᵢ, . . . , Fₙ} of its parent node or Aᵢ→Fᵢ.

7. The method of claim 3, wherein the decision outputs of every node is available for generating decision reports.

8. The method of claim 3, wherein an action output of the root node can trigger control actions or other decision processes.

9. The method of claim 3, wherein input counters and output actions of all nodes of a decision tree can used for generating a decision report.

10. The method of claim 5, wherein a user can specify input sources for each node.

11. The method of claim 5, wherein a user can set whether a node participates in the current decision process or not.

12. The method of claim 1, wherein a decision process of a decision tree can be performed on multiple computer devices including, but not limited to, a personal computers, computer server, tablets, smart phones, and cloud servers.

13. The method of claim 10, wherein a decision tree can be processed in multiple computer processors.

14. The method of claim 10, wherein any sub-tree of a decision tree can be processed in a computer process independently.

15. The method of claim 1, wherein the distributed decision trees can be stored in encrypted formation.

16. The method of claim 3, wherein a user can define functions for a node.

17. The method of claim 3, wherein a user can schedule to adjust decision functions using learning functions.

18. The method of claim 1, wherein users can share decision trees by a copying or linking method.
